(19) United States
(12) Patent Application Publication
(10) Pub. No.: US 2020/0070077 A1
(43) Pub. Date: Mar. 5, 2020

(54) SUPERCHARGER PROTECTION IN AN OPPOSED-PISTON ENGINE WITH EGR

(71) Applicant: Achates Power, Inc., San Diego, CA (US)

(72) Inventors: Nicholas J. Rakovec, San Diego, CA (US); John K. Bandimere, San Diego, CA (US)

(73) Assignee: Achates Power, Inc., San Diego, CA (US)

(21) Appl. No.: 16/666,089

(22) Filed: Oct. 28, 2019

Related U.S. Application Data
(63) Continuation of application No. PCT/US2018/033231, filed on May 17, 2018.
(60) Provisional application No. 62/517,521, filed on Jun. 9, 2017.

(51) Int. Cl. B01D 45/06; F01B 7/14

(52) U.S. Cl. CPC B01D 45/06; F02D 41/0007; F01B 7/14

(57) ABSTRACT

In a supercharged, two-stroke cycle, opposed-piston engine with an EGR loop, exhaust gas recirculated to a charge air channel through which intake air is provided to a supercharger inlet is cleansed of particulate matter by a separator disposed either at a junction where an exhaust channel of the engine is tapped for recirculated exhaust, or, in the EGR loop.

### PRIORITY

This application is a continuation of PCT application PCT/US2018/033231, filed May 17, 2018, which claims priority to U.S. provisional application for patent 62/517,521, filed 9 Jun. 2017.

### FIELD OF THE INVENTION

The invention is directed to an opposed-piston internal combustion engine with an air handling system uniquely equipped to protect a supercharger from damaging effects attributable to exhaust gas recirculation.

More particularly, the EGR loop is uniquely configured to mitigate the effects of particles that are present in exhaust gas being recirculated to a stream of charge air that is fed to the input of a supercharger.

### BACKGROUND OF THE INVENTION

Gas flow through a two-stroke cycle, opposed-piston engine is not assisted by any pumping action of the pistons, as occurs in a four-stroke engine with a single piston in each cylinder. Charge air must be continuously pumped by means external to the cylinders. Such means typically include a mechanically-driven supercharger situated downstream of a turbocharger in the direction of charge air flow. The supercharger maintains a positive pressure drop across the engine that ensures forward motion through the engine of the charge air and exhaust at all engine speeds and loads, a condition that cannot be met by the turbocharger. In addition, the supercharger provides needed boost quickly in response to torque demands to which the turbocharger responds more slowly. In many cases, cold start of a two-stroke cycle, opposed-piston engine is enabled by the supercharger pumping air through the charge air system. Finally, for those two-stroke cycle opposed-piston engine configurations equipped with high-pressure exhaust gas recirculation (EGR), the supercharger maintains a positive pressure drop across the EGR loop that ensures the transport of exhaust gas through it.

Manifestly, reliable operation of the supercharger is a critical factor in meeting the performance and emission goals of a two-stroke cycle opposed-piston engine. Poor, deteriorating, or otherwise impaired supercharger operation must therefore be avoided. However, the integrity of supercharger operation can be severely compromised by the recirculated exhaust gas.

Exhaust gas recirculation is an effective means for reducing certain exhaust impurities that are produced by burning fuel in a high temperature combustion process. Recirculation of a portion of exhaust gasses into an incoming stream of charge air serves to reduce the amount of oxygen in the charge air provided to the engine, thereby reducing peak temperatures of combustion. However, recirculated exhaust gas, particularly exhaust recirculated through a high-pressure EGR loop, typically includes particulate matter (PM) such as soot and unburned hydrocarbons, both of which are harmful to air handling components in the charge air system. A price paid for high-pressure EGR operation is a reduction in supercharger performance and lifetime. In particular, PM introduced by recirculation of exhaust into the charge air deposits readily on the surfaces of internal components of the supercharger such as rotors, housing, bearings, gears, etc., largely due to thermophoresis. Accumulation of PM deposits can lead to reduction in supercharger performance resulting in increased pumping loss and reduced operational efficiency. Ultimately, fouling and clogging can cause failure of the device.

Accordingly, it is desirable to solve the problem of supercharger vulnerability to damaging effects of high pressure EGR in a two-stroke cycle, opposed-piston engine.

### SUMMARY OF THE INVENTION

According to an aspect of the invention, in a supercharged, two-stroke cycle, opposed-piston engine with an EGR loop, exhaust gas recirculated to a charge air channel through which charge air is provided to a supercharger inlet is cleansed of particulate matter by a separator apparatus acting between an exhaust channel of the engine and the charge air channel to remove particulate matter from exhaust gas. In some instances, the separator apparatus is disposed at a junction where the exhaust channel is tapped for recirculated exhaust. In other instances, the separator apparatus is situated in the EGR loop or in the exhaust channel.

In some instances, the separator apparatus is disposed at a junction where the exhaust channel is tapped for recirculated exhaust. In other instances, the separator is situated in the EGR loop or in the exhaust.

In some respects the separator apparatus is situated at a junction between the exhaust channel and the EGR loop. In other aspects an in-line separator apparatus is situated in the EGR loop to remove particles from exhaust gas which is provided to the EGR loop from an exhaust channel of the engine.

### BRIEF DESCRIPTION OF THE DRAWINGS

FIG. 1 is a diagram of an opposed-piston engine equipped with an air handling system and is properly labeled “Prior Art.”

FIG. 2 is a schematic diagram showing an air handling system of an opposed-piston engine equipped with a separator apparatus to provide a reduced-particulate EGR flow according to a first embodiment of the invention.

FIG. 3A is a schematic diagram showing a first separator apparatus construction to provide a reduced-particulate EGR flow according to the first embodiment of the invention.

FIG. 3B is a schematic diagram showing a second separator apparatus construction to provide a reduced-particulate EGR flow according to the first embodiment of the invention.

FIG. 4 is a schematic diagram showing an air handling system of an opposed-piston engine equipped with a separator apparatus to provide a reduced-particulate EGR flow according to a second embodiment of the invention.

FIG. 5 shows, a separator apparatus to provide a reduced-particulate EGR flow according to the second embodiment of the invention.

### DETAILED DESCRIPTION OF THE PREFERRED EMBODIMENTS

A two-stroke cycle engine is an internal combustion engine that completes a cycle of operation with a single complete rotation of a crankshaft and two strokes of a piston connected to the crankshaft. The strokes are typically denoted as compression and power strokes. One example of a two-stroke cycle engine is an opposed-piston engine in which two pistons are disposed in the bore of a cylinder for reciprocating movement in opposing directions along the central axis of the cylinder. Each piston moves between a bottom center (BC) location where it is nearest one end of the cylinder and a top center (TC) location where it is furthest from the one end. The cylinder has ports formed in the cylinder sidewall near respective BC piston locations. Each of the opposed pistons controls one of the ports, opening the port as it moves to its BC location, and closing the port as it moves from BC toward its TC location. One of the ports serves to admit charge air (sometimes called “scavenging air”) into the bore, the other provides passage for the products of combustion out of the bore; these are respectively termed “intake” and “exhaust” ports (in some descriptions, intake ports are referred to as “air” ports or “scavenge” ports). In a uniflow-scavenged opposed-piston engine, pressurized charge air enters a cylinder through its intake port as exhaust gas flows out of its exhaust port, thus gas flows through the cylinder in a single direction (“uniflow”)—from intake port to exhaust port.

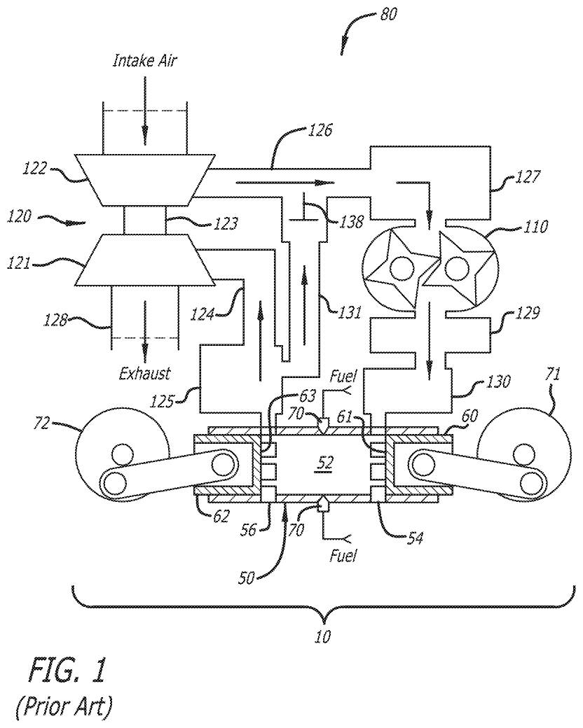

With reference to FIG. 1, a two-stroke cycle internal combustion engine is embodied in an opposed-piston engine 10 having at least one ported cylinder 50. For example, the engine may have one ported cylinder, two ported cylinders, three ported cylinders, or four or more ported cylinders. Each ported cylinder 50 has a bore 52 and longitudinally spaced intake and exhaust ports 54 and 56 formed or machined in respective ends of a cylinder wall. Each of the intake and exhaust ports 54 and 56 includes one or more circumferential arrays of openings in which adjacent openings are separated by a solid bridge. In some descriptions, each opening is referred to as a “port”; however, the construction of a circumferential array of such “ports” is no different than the port constructions shown in FIG. 1. Pistons 60 and 62 are slideably disposed in the bore 52 of each cylinder with their end surfaces 61 and 63 opposing one another. Movements of the pistons 60 control the operations of the intake ports 54. Movements of the pistons 62 control the operations of the exhaust ports 56. Thus, the ports 54 and 56 are referred to as “piston controlled ports”. Pistons 62 controlling the exhaust ports (“exhaust pistons”) are coupled to a crankshaft 72. Pistons 60 controlling the intake ports of the engine (“intake ports”) are coupled to a crankshaft 71.

As pistons 60 and 62 approach respective TC locations, a combustion chamber is defined in the bore 52 between the end surfaces 61 and 63. Fuel is injected directly into the combustion chamber through at least one fuel injector nozzle 70 positioned in an opening through the sidewall of a cylinder 50. The fuel mixes with charge air admitted through the intake port 54. As the mixture is compressed between the end surfaces it reaches a temperature that causes the fuel to ignite; in some instances, ignition may be assisted, as by spark or glow plugs. Combustion follows.

The engine 10 has an air handling system 80 that manages the transport of charge air provided to, and exhaust gas produced by, the engine 10 during operation of the engine. A representative air handling system construction includes a charge air subsystem and an exhaust subsystem. The charge air subsystem receives and compresses air and includes a charge air channel that delivers the compressed air to the intake port or ports of the engine. The charge air subsystem may comprise one or both of a turbine-driven compressor and a supercharger. The charge air channel typically includes at least one air cooler that is coupled to receive and cool the charge air (or a mixture of gasses including charge air) before delivery to the intake ports of the engine. The exhaust subsystem includes an exhaust channel that transports exhaust products from exhaust ports of the engine for delivery to other exhaust components and release to the ambient atmosphere.

A typical air handling system for an opposed-piston engine is shown in FIG. 1. The air handling system 80 may comprise a turbocharger 120 with a turbine 121 and a compressor 122 that rotate on a common shaft 123. The turbine 121 is coupled to the exhaust subsystem and the compressor 122 is coupled to the charge air subsystem. The turbocharger 120 extracts energy from exhaust gas that exits the exhaust ports 56 and flows into an exhaust channel 124 that is fluidly coupled to an exhaust manifold, plenum, or chest 125 (collectively, “exhaust manifold”, for convenience) which collects exhaust gasses output through the exhaust ports 56. In this regard, the turbine 121 is rotated by exhaust gas passing through it. This rotates the compressor 122, causing it to generate charge air by compressing fresh air. Charge air output by the compressor 122 flows through a charge air channel 126. The charge air channel 126 includes the compressor 122, a supercharger 110 downstream of the compressor in the direction of charge air flow, and an intake manifold, plenum, or chest 130 (collectively, “intake manifold”, for convenience). The charge air channel may further include at least one charge air cooler 127 (hereinafter, “cooler”) to receive and cool the charge air before delivery to the intake port or ports of the engine. Charge air transported to the supercharger 110 is output to the intake manifold 130. The intake ports 54 receive charge air pumped by the supercharger 110 via the intake manifold 130. A second cooler 129 may be provided between the output of the supercharger 110 and the input to the intake manifold 130.

The air handling system 80 is equipped to reduce NOx emissions produced by combustion by recirculating a portion of the exhaust gas produced by combustion through the ported cylinders of the engine. The recirculated exhaust gas is mixed with charge air to lower peak combustion temperatures, which reduces production of NOx. This process is referred to as exhaust gas recirculation (“EGR”). The EGR construction shown obtains a portion of the exhaust gasses flowing from the exhaust manifold 125 during scavenging and transports it via an EGR channel 131 into the stream of charge air in the charge air subsystem. The recirculated exhaust gas flows through the EGR channel 131 under the control of a valve 138 (this valve may also be referred to as the “EGR valve”). The EGR arrangement of FIG. 1 is referred to as a high pressure EGR loop because the portion of the exhaust gas to be recirculated is taken from the exhaust channel 124, upstream of the inlet of the turbine 121 in the direction of exhaust flow, where the exhaust gas pressure is relatively higher than at the turbine's outlet.

The invention is directed to an air handling system of a supercharged, two-stroke cycle, opposed-piston engine with an EGR loop in which exhaust gas is recirculated to a charge air channel through which charge air is provided to a supercharger inlet. The exhaust gas provided for recirculation is cleansed of particulate matter by a separator apparatus acting between an exhaust channel of the engine and the charge air channel. in this regard a “separator apparatus” is an apparatus that separates a flow of exhaust gas with a relatively low concentration of particulate matter from a flow of exhaust gas that has a relatively higher concentration of particulate matter. The separator apparatus operates principally by one of an inertial effect, a centrifugal effect, a cyclonic effect, and a vortex effect. The scope of the term “separator apparatus” does not include a gas flow filter.

### First Embodiment

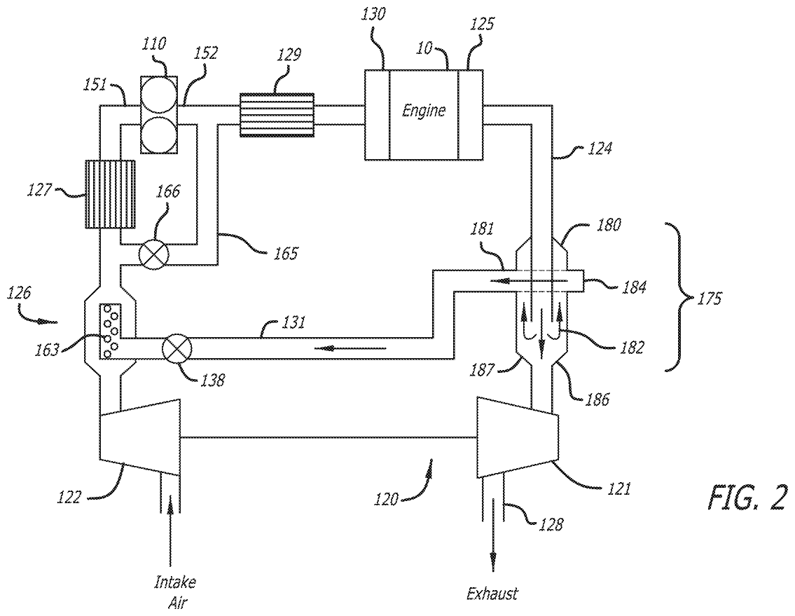

FIG. 2 shows the air handling system 80 in greater detail, equipped according to a first embodiment of the invention in which a separator apparatus is disposed at a junction where the exhaust channel of the engine is tapped for recirculated exhaust.

Intake air is provided to the compressor 122. As the compressor 122 rotates, compressed air flows from the compressor's outlet, through the charge air channel 126, and into the inlet 151 of the supercharger 110. Charge air pumped by the supercharger 110 flows through the superchargers outlet 152 into the intake manifold 130. Pressurized charge air is delivered via the intake manifold 130 to the intake ports of the engine. Exhaust gasses collected from the exhaust ports of the engine flow from the exhaust manifold 125 into the inlet of the turbine 121, and from the turbine's outlet into an exhaust outlet channel 128. In some instances, one or more after treatment (AT) devices may be provided in the exhaust outlet channel 128. Exhaust gas recirculated via the high-pressure EGR channel 131 is obtained from the exhaust channel 124 at a junction between the exhaust manifold 125 and the input to the turbine 121. The recirculated exhaust is delivered by the EGR channel 131 for mixing with fresh charge air at a point between the output of the compressor 122 and the supercharger inlet 151. The amount of exhaust flowing through the EGR channel 131 is controlled by the EGR valve 138. The EGR channel 131 is coupled to the charge air subsystem via an EGR mixer 163 wherein the recirculated exhaust is combined with pressurized air output by the compressor 122. The mixer 163 outputs the charge air, which is supplied to the elements positioned downstream of the mixer including the supercharger 110.

The air handling system 80 is equipped for control of gas flow at separate control points in the charge air and exhaust channels. In the charge air channel, charge air flow and boost pressure are controlled by operation of a recirculation channel 165 coupling the outlet 152 of the supercharger to the supercharger's inlet 151. In some instances, the channel 165 may be referred to as a “bypass channel” or a “shunt channel.” The recirculation channel 165 shunts charge air flow from the outlet 152 to the inlet 151 of the supercharger according to the setting of a recirculation valve 166. The recirculation channel enables control of the flow of charge air into, and thus the pressure in, the intake manifold 130. Other valves (which are not shown) may be provided at other control points in the air handling system. In other cases (not shown) the supercharger 110 may be coupled to a crankshaft by a multi-speed drive, which could eliminate the need for the recirculation channel.

According to the first embodiment of the invention, the air handling system 80 is provided with a separator apparatus 175 which is situated at the junction between the exhaust subsystem and the EGR channel 131 to collect exhaust gas from the exhaust channel 124 for recirculation to the charge air channel 126. The separator apparatus 175 reduces the amount of PM in the exhaust gas that is collected for recirculation. The PM particles are heavier than the gaseous exhaust constituents and prefer to continue moving forward in a main stream of exhaust, toward the turbine 121. Within the separator apparatus 175, a main stream of exhaust gas containing particulate matter flows forward from the exhaust manifold 125 to the turbine 121 in a straight line through the separator apparatus 175. However, the construction of the separator 175 provides a change in flow direction from the straight line for the exhaust gas circulating towards the outlet of the separator apparatus 175. For example, the change in flow direction may be provided in a bending flow path with a turn of 90° or more. In another instance the change of flow direction may comprise a reversal of direction, that is to say, a bending flow path with a turn of up to 180°. The bending flow path allows an expanding portion of the exhaust gas to separate from the main stream of exhaust gas. Inertia keeps most, if not all, of the PM moving in a straight line with the main stream of exhaust gas. As a result, the PM concentration in the recirculated exhaust gas transported in the bending flow path leading to the EGR channel 131 is substantially reduced from that in the main stream of exhaust flowing to the turbine inlet.

The separator apparatus 175, which is located upstream of the EGR valve 138 against the direction of EGR flow, comprises an expanding outer conduit pipe 180 which houses an inner supply conduit pipe 182 and a collection chamber 184. The principal outlet 186 of the separator apparatus 175 may comprise a converging cone 187 through which the exhaust gas flows to the turbine 121. A secondary outlet 181 of the separator apparatus 175 conveys exhaust gas from which PM has been separated from the collection chamber 184 to the EGR channel 131.

Exhaust gasses with concentrations of particulate matter collected from the exhaust ports of the cylinders flow from the exhaust manifold 125 into the separator apparatus 175 through the inner supply conduit pipe 182. As these gasses exit the an inner supply conduit pipe 182, they flow in a substantially straight line path into the expanding outer conduit pipe 180, with the bulk of the exhaust gasses continuing to flow through the converging cone 187 forward out of the principal outlet 186 to the turbine 121. Most, if not all, of the heavy particulate matter follows this straight line path to the turbine 121 due to inertia and so does not enter the EGR channel 131. A portion of the exhaust gas expands outwardly into the outer conduit pipe 180 thereby separating from the exhaust gas stream that flows in a substantially straight line and changes direction so as to be flowing toward the EGR collection chamber 184. Optionally, the separator apparatus 175 may comprise a perforated member associated with the collection chamber 184, so as to further reduce the particle concentration in the separated exhaust gas through Brownian diffusion and impaction. The reduction in particles being introduced into the charge air subsystem significantly cleanses the mixture of charge air and exhaust being input to the supercharger 110, thereby alleviating the fouling of the device and making it more durable.

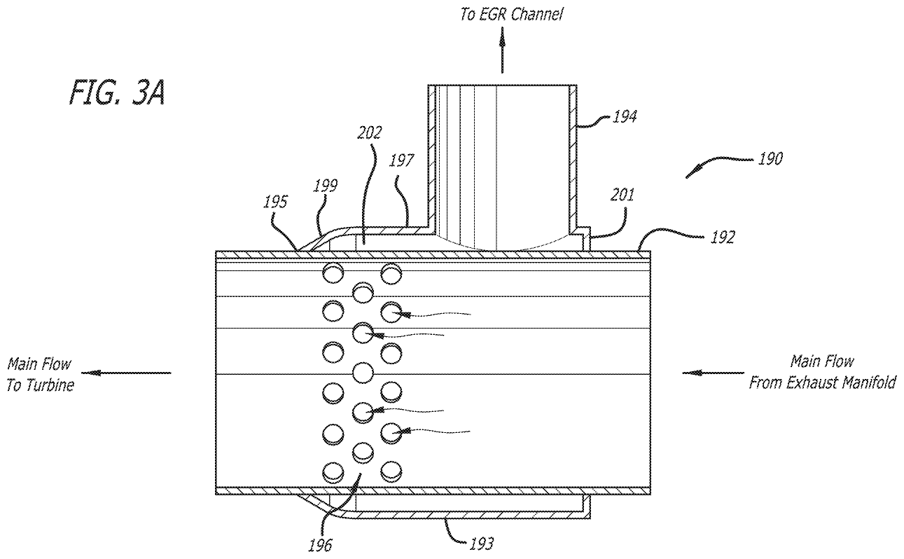

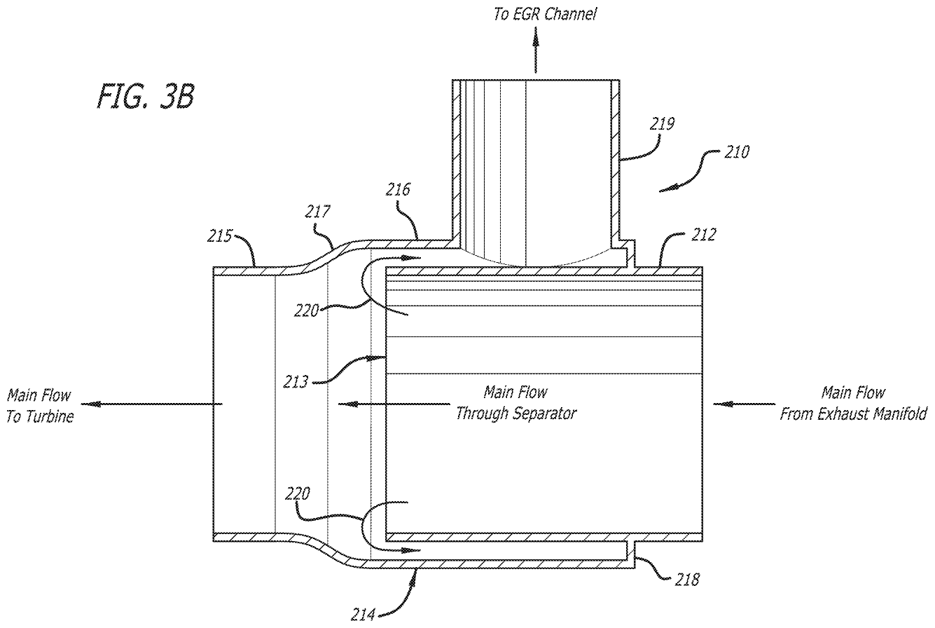

FIG. 3A shows an apparatus construction for separating a flow of exhaust gas for a high-pressure EGR channel from a flow of exhaust gas containing PM and other particles as per the air handling system construction shown in FIG. 2. This separator apparatus is constructed to be positioned at a junction between the EGR channel and an exhaust channel of a two-stroke cycle, opposed-piston engine, and so may be termed a “junction separator.” The junction separator apparatus 190 includes a main pipe 192 that transports a main flow of exhaust gas streaming in a direction from an exhaust manifold to the turbine inlet of a turbocharger. An EGR collector chamber 193 surrounds the main pipe 192. By way of example, the main pipe may have a substantially cylindrical construction with a diameter D, and the collector chamber 193 may have a substantially cylindrical configuration with a first portion 195 having a diameter D₁ that is slightly larger than D, and a second portion 197 having a diameter D₂ that is larger than D ₁. The first and second portions may be joined by a frusta-conical shoulder portion 199. The first portion 195 of the collector chamber is sealed to the outer surface of the main pipe 192. A flange 201 with a substantially annular configuration forms a seal between the main pipe 192 and the second portion 197 of the collector chamber. An array of perforations 196 is formed in a portion of the main pipe 192 that is surrounded by the collector chamber 193. Preferably, the array of perforations 196 is situated at least partially within the shoulder portion, which locates it nearer the turbine in the direction of exhaust flow. An EGR pipe 194 couples the collector chamber 193 to an EGR channel of a high-pressure EGR loop.

In the example shown in FIG. 3A, a portion of the exhaust gas expands from the main flow, via a bending flow path 202 through the perforations 196 into the collector chamber 193. The bending flow path 202 through the array of perforations 196 includes a turn into the collector chamber 193. In the example shown, the turn is substantially 180°, although this is not meant to be limiting. Large particles in the main exhaust flow will have too much inertia to be able to follow the bending flow path 202, resulting in a reduced particle EGR flow. The size and shape of the perforations, and the extent and density of the array may be varied to achieve further separation of smaller particles.

FIG. 3B shows another apparatus construction for separating a flow of exhaust gas for a high-pressure EGR channel from a flow of exhaust gas containing PM and other particles as per the air handling construction shown in FIG. 2. The device is constructed to be positioned at a junction between the EGR channel and an exhaust channel of a two-stroke cycle, opposed-piston engine, and so may be termed a “junction separator.” The junction separator apparatus 210 includes a first main pipe portion 212 with an open end 213 that is surrounded by a fitting 214. By way of example, the first main pipe portion 212 may have a substantially cylindrical construction with a diameter D. The fitting 214 may have a substantially cylindrical configuration with a second main pipe portion 215 having a diameter D₁that is substantially equal to D, and a collector portion 216 having a diameter D₂ that is larger than D₁. The second main pipe and collector portions may be joined by a frusta-conical shoulder portion 217. A flange 218 with a substantially annular configuration forms a seal between the first main pipe portion 212 and the collector portion 216 and substantially coaxially aligns the first main pipe portion 212 with the second main pipe portion 215. An EGR pipe 219 couples the collector portion 216 to an EGR channel of a high-pressure EGR loop.

In the example shown in FIG. 3B, a portion of the exhaust gas expands from the main flow, following a bending flow path 220 around the open end 213 of the first main pipe portion 212. The bending flow path 220 around the open end 213 includes a turn into the collector portion 217 of the fitting. In the example shown, the turn is substantially 180°, although this is not meant to be limiting. Large particles in the main exhaust flow will have too much inertia to be able to follow the turn, resulting in a reduced particle EGR flow.

Other separator configurations are contemplated for the first embodiment. Some of these other configurations may utilize guided flow principles employing deflectors and/or shaped conduits to achieve cyclonic, centrifugal or vortex-type effects that radially separate the main flow of exhaust into particle-rich and particle-lean portions, with EGR flow being collected from the particle-lean portion.

A junction separator configuration has a simple configuration that contains no moving parts. The separator is a passive device that does not require additional control strategy. Elimination of large and middle sized particles from the EGR stream substantially reduces problems associated with fouling of the supercharger and additional air handling elements downstream of the mixer, including one or more coolers and one or more valves

### Second Embodiment

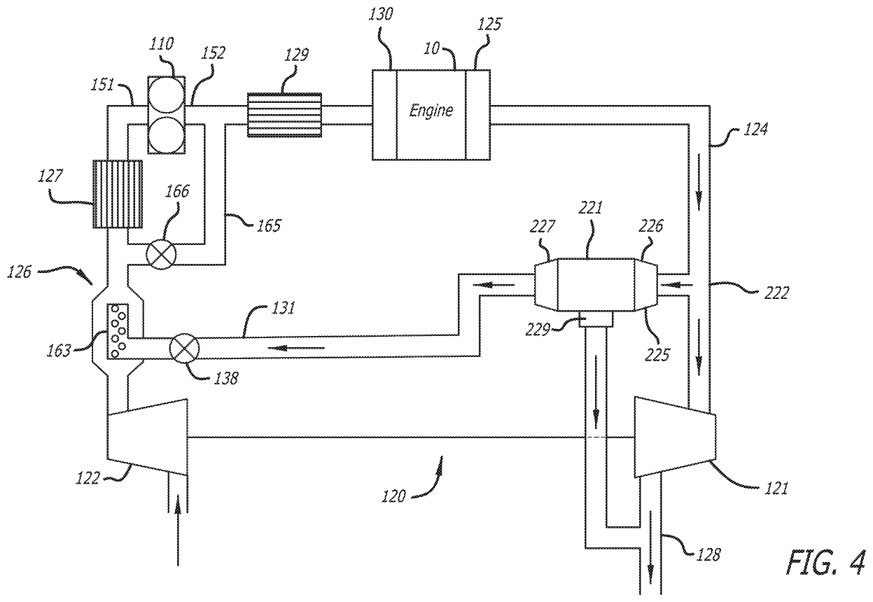

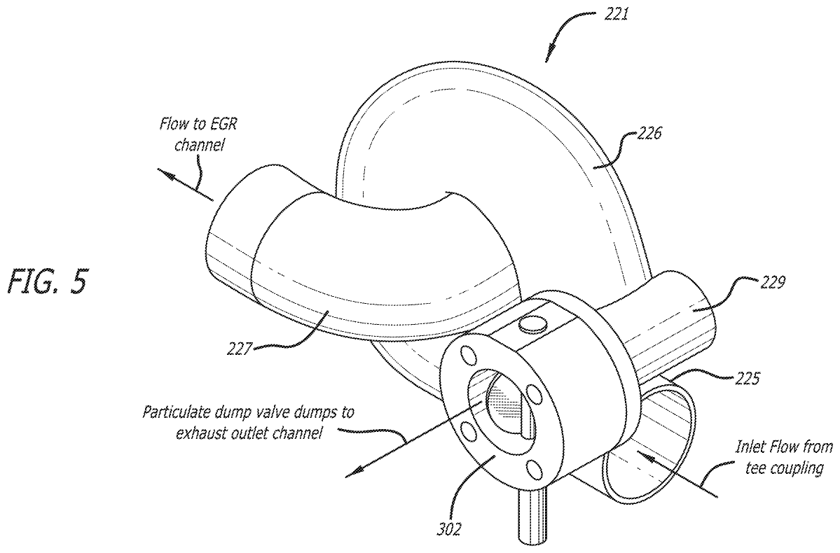

FIG. 4 shows the air handling system 80 in greater detail, equipped according to a second embodiment of the invention in which an in-line separator apparatus 221 is situated in the EGR loop 131 to remove particles from recirculated exhaust gas that has been diverted from a main flow of exhaust gas through the exhaust channel 124. In this regard, recirculated exhaust gas containing particulate matter is obtained by a tee coupling 222 from the exhaust channel 124. The separator apparatus 221, which is situated in the EGR channel 131 between the EGR valve 138 and the tee coupling 222, utilizes inertial and centrifugal forces to separate large particles from the EGR stream. The separator apparatus 221 has an inlet pipe 225, a cyclonic particle collector 226, an EGR outlet 227, and a valve-controlled particle outlet 229 that is coupled to the exhaust outlet channel 128. As per FIGS. 4 and 5, exhaust gas collected from the tee coupling enters the separator apparatus 221 through the inlet pipe 225 and flows into a scrolled particle collector 226, which exerts a cyclonic, centrifugal, or vortex-type rotation on the exhaust gas causing the PM to flow outwardly toward the wall of the particle collector 226. The EGR flow through the outlet 227 pulls from the center of the cyclonic, centrifugal, or vortex-type rotation, and so has a reduced particle concentration. The particulate-heavy flow is emptied from the particle collector 226 through the outlet 229, under control of a valve 302. Because the in-line separator is located in the EGR stream, it can be built to accommodate a lower mass flow than the junction separator of the first embodiment, which potentially allows for a smaller package and a lower pressure drop. One challenge with the in-line separator is the requirement for a valve that would need to be incorporated into the overall air handling control strategy.

Those skilled in the art will appreciate that the separators described herein are based on separation of particles by means other than filtration, that is to say, by means that do not substantially increase gas flow resistance in the exhaust channel and/or the EGR channel. Accordingly the separators are not gas flow filters.

Those skilled in the art will realize that the EGR loop configuration shown in FIGS. 2 and 4 may comprise one or more elements in addition to the valve 138. For example, the EGR channel 131 may also have one or more sensor devices to measure mass flow. Further, the air handling cooling arrangements may include a cooler located in the EGR channel 131. In any case, a separator according to the first and second embodiments of the invention is positioned upstream of any and all elements in the EGR channel 131.

The high-pressure EGR loop of the embodiments is not meant to be limiting. In other embodiments, the air handling system may additionally or alternatively include a low-pressure EGR system in which exhaust gas for recirculation can be obtained from the exhaust channel downstream of the turbine output and cleansed of PM in the manner shown in FIGS. 2 and 4.

Those skilled in the art will appreciate that the specific embodiments set forth in this specification are merely illustrative and that various modifications are possible and may be made therein without departing from the scope of the invention which is defined by the following claims.

1. An air handling system in an internal combustion engine, comprising:
a source of exhaust gas collected from cylinder exhaust ports of a two-stroke cycle, opposed-piston engine;
a supercharger coupled to an intake manifold of the two-stroke cycle, opposed-piston engine;
an exhaust channel to transport collected exhaust from the exhaust source to a turbine inlet of a turbocharger;
a charge air channel to transport charge air from a compressor outlet of the turbocharger to an inlet of the supercharger;
an exhaust gas recirculation (EGR) channel to transport exhaust gas from the exhaust channel to the charge air channel; and,
a particle separator apparatus acting between the exhaust channel and the EGR channel to remove particulate matter from the exhaust gas.

2. An air handling system according to claim 1, in which the particle separator apparatus couples the exhaust channel to the EGR channel.

3. An air handling system according to claim 2, further comprising a recirculation channel to shunt charge air flow from an outlet of the supercharger to the inlet of the supercharger.

4. An air handling system according to claim 2, further comprising at least one charge air cooler in the charge air channel.

5. An air handling system according to claim 2, further comprising a multi-speed drive coupling the supercharger to a crankshaft of the two-stroke cycle, opposed-piston engine.

6. An air handling system according to claim 2, further comprising an exhaust outlet channel and one or more after treatment (AT) devices in the exhaust outlet channel.

7. An air handling system according to claim 1, in which the particle separator is in the EGR channel.

8. An air handling system according to claim 7, further comprising a recirculation channel to shunt charge air flow from an outlet of the supercharger to the inlet of the supercharger.

9. An air handling system according to claim 7, further comprising at least one charge air cooler in the charge air channel.

10. An air handling system according to claim 7, further comprising a multi-speed drive coupling the supercharger to a crankshaft of the two-stroke cycle, opposed-piston engine.

11. An air handling system according to claim 7, further comprising an exhaust outlet channel and one or more after treatment (AT) devices in the exhaust outlet channel.

12. An air handling system according to claim 1, in which the particle separator apparatus comprises means coupled to the exhaust channel and to the EGR channel for:
collecting exhaust gas from the exhaust channel; removing particulate matter from the collected exhaust gas; and, providing collected exhaust gas with particulate matter removed therefrom to the EGR channel.

13. An air handling system according to claim 12, further comprising a recirculation channel to shunt charge air flow from an outlet of the supercharger to the inlet of the supercharger.

14. An air handling system according to claim 12, further comprising at least one charge air cooler in the charge air channel.

15. An air handling system according to claim 12, further comprising a multi-speed drive coupling the supercharger to a crankshaft, of the two-stroke cycle, opposed-piston engine.

16. An air handling system according to claim 12, further comprising an exhaust outlet channel and one or more after treatment (AT) devices in the exhaust outlet channel.

17. An air handling system according to claim 1, wherein the particle separator apparatus is coupled to the exhaust channel and to the EGR channel and comprises a bending flow path for separating a reduced particle EGR flow from the main flow and providing the separated reduced particle EGR flow to the EGR channel.

18. An air handling system according to claim 17, further comprising a recirculation channel to shunt charge air flow from an outlet of the supercharger to the inlet of the supercharger.

19. An air handling system according to claim 17, further comprising at least one charge air cooler in the charge air channel.

20. An air handling system according to claim 17, further comprising a multi-speed drive coupling the supercharger to a crankshaft of the two-stroke cycle, opposed-piston engine.

21. An air handling system according to claim 17, further comprising an exhaust outlet channel and one or more after treatment (AT) devices in the exhaust outlet channel.

22. An air handling system according to claim 1, wherein the particle separator apparatus comprises means in the EGR channel for removing particulate matter from exhaust gas by one or more of cyclonic, centrifugal, or vortex-type rotation of the exhaust gas.

23. An air handling system according to claim 22, further comprising a recirculation channel to shunt charge air flow from an outlet of the supercharger to the inlet of the supercharger.

24. An air handling system according to claim 22, further comprising at least one charge air cooler in the charge air channel.

25. An air handling system according to claim 22, further comprising a multi-speed drive coupling the supercharger to a crankshaft of the two-stroke cycle, opposed-piston engine.

26. An air handling system according to claim 22, further comprising an exhaust outlet channel and one or more after treatment (AT) devices in the exhaust outlet channel.

27. An air handling system according to claim 1, wherein the particle separator apparatus comprises means coupling the EGR channel to the exhaust channel for removing particulate matter from exhaust gas provided to the EGR channel by inertial action of the particulate matter in the exhaust channel.

28. An air handling system according to claim 27, further comprising a recirculation channel to shunt charge air flow from an outlet of the supercharger to the inlet of the supercharger.

29. An air handling system according to claim 27, further comprising at least one charge air cooler in the charge air channel.

30. An air handling system according to claim 27, further comprising a multi-speed drive coupling the supercharger to a crankshaft of the two-stroke cycle, opposed-piston engine.

31. An air handling system according to claim 27, further comprising an exhaust outlet channel and one or more after treatment (AT) devices in the exhaust outlet channel.
